(19) United States
(12) Patent Application Publication
(10) Pub. No.: US 2021/0285476 A1
(43) Pub. Date: Sep. 16, 2021

(54) MAGNET-DRIVEN CONNECTORS

(71) Applicant: Hewlett-Packard Development Company, L.P., Spring, TX (US)

(72) Inventors: Po-Feng Chuang, Taipei City (TW); Kun-Hung Lin, Taipei City (TW); Shih-Hua Chang, Taipei City (TW)

(73) Assignee: Hewlett-Packard Development Company, L.P., Spring, TX (US)

(21) Appl. No.: 17/262,361

(22) PCT Filed: Nov. 7, 2018
(86) PCT No.: PCT/US2018/059514

§ 371 Date: Jan. 22, 2021

(51) Int. Cl. F16B 5/02

(52) U.S. Cl. CPC F16B 5/0208; G06F 1/1656

(57) ABSTRACT

In one example, a magnet-driven connector may Include a module housing and a core module disposed In the module housing. The core module may include a protruding screw and a rotary magnetizer in contact with the protruding screw to magnetically drive the protruding screw to engage or disengage with a threaded hole of a nut portion. Further, the magnet-driven connector may include an elastic member between the core module and a bottom cover of the module housing. Furthermore, the magnet-driven connector may include a low-friction film disposed between the core module and the module housing.

### BACKGROUND

Fasteners are used to fasten components. Example components may include a top case and a bottom case that form an enclosure of an electronic device. Example electronic devices may include laptop computers, tablet computers, convertible devices, mobile phones, cameras, personal digital assistants, and the like. The top case and the bottom case may be coupled using the fasteners.

### BRIEF DESCRIPTION OF THE DRAWINGS

Examples are described in the following detailed description and in reference to the drawings, in which:

FIG. 1A is a cross-sectional view of an example magnet-driven connector, depicting a low-friction film between a core module and a module housing;

FIG. 1B is a cross sectional view of the example magnet-driven connector of FIG. 1A, depicting additional features;

FIG. 2 is a schematic diagram of the example magnet-driven connector of FIG. 1A, depicting a non-smooth texture on an outer surface;

FIG. 3 is a cross-sectional view of an example magnet-driven connector, depicting a magnet rotatably received in a screw portion and non-rotatably received in a magnet holder;

FIG. 4 is an exploded view of the example magnet-driven connector of FIG. 3, depicting additional features;

FIG. 5 is a schematic diagram of an example core module of FIG. 4, depicting the magnet holder to fixedly hold the magnet and in contact with the screw portion; and

FIGS. 6A and 6B are cross-sectional views of a portion of an example device housing including an example connector to connect a first cover and a second cover.

### DETAILED DESCRIPTION

Fasteners such as screws, nuts, and the like may be used to join various components together in a variety of applications. However, using fasteners to secure a part having an exterior cosmetic surface may result in a visible opening or at least a fastener head being visible after the product is assembled. The exposed fasteners may affect the aesthetic appearance of the product such as a notebook computer, a tablet computer, a mobile device, a camera, or any other product having components connected using the fasteners. Furthermore, in some examples, the visibility of an external fastener may also allow to access components disposed within a device housing. In devices involving tamper resistance, a readily visible fastener can be undesirable. Also, the assembly and disassembly process using the fasteners may be cumbersome as the fasteners can be slipped.

Examples described herein may provide a magnet-driven connector to connect components such as casings of an electronic device. The magnet-driven connector may include a module housing, a core module disposed in the module housing, an elastic member disposed between the core module and a bottom cover of the module housing, and a low-friction film disposed between the core module and the module housing. The low-friction film may reduce friction between the core module and the module housing during rotation of the core module. The core module may include a screw portion comprising a protruding screw, a magnet, and a magnet holder to fixedly hold the magnet and in contact with the screw portion.

The magnet may be drivable in a rotary manner by means of an external magnet device, for instance, an electric or pneumatic tool. Further, the magnet holder may rotate along with the magnet. The rotation of the magnet holder may drive the protruding screw to rotate in a clockwise or an anti-clockwise direction such that the protruding screw can be connected to or detached from a threaded hole of a nut portion. Thus, examples described herein may improve the aesthetic appearance of the electronic devices and/or any other structures as no parts of the magnet-driven connector can be exposed after installation and also provide an enhanced mechanical strength.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described may be included in at least that one example, but not necessarily in other examples.

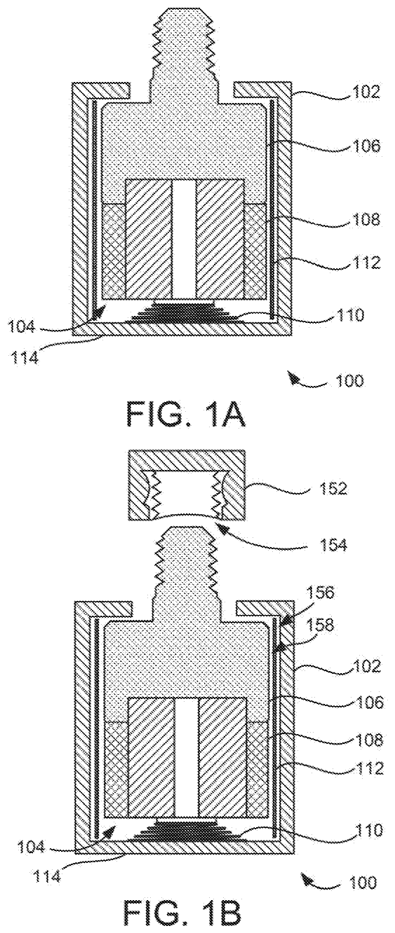

Referring now to the figures, FIG. 1A is a cross-sectional view of an example magnet-driven connector 100, depicting a low-friction film 112 between a core module 104 and a module housing 102. For example, magnet-driven connector 100 may be used to connect components such as casings of an electronic device. In other examples, magnet-driven connector 100 may also be used to connect any two parts such as to connect furniture or machine parts.

Magnet-driven connector 100 may include module housing 102 and core module 104 disposed in module housing 102. Core module 104 may include a protruding screw 106 and a rotary magnetizer 108 in contact with protruding screw 106. In one example, rotary magnetizer 108 may be connected to protruding screw 106. Further, rotary magnetizer 108 may include a magnet to magnetically drive protruding screw 106 to engage or disengage with a threaded hole of a nut portion.

In one example, magnet-driven connector 100 may use the principle of the opposite phase suction of the magnetic pole, so that rotary magnetizer 108 may rotate under the driving of a magnet device such as an electric or pneumatic tool. As the magnetic pole rotates continuously, rotary magnetizer 108 that drives protruding screw 106 can be rotated. Further, the rotation of rotary magnetizer 108 may drive protruding screw 106 to rotate, thereby tightening or loosening protruding screw 106.

Further, magnet-driven connector 100 may include an elastic member 110 between core module 104 and a bottom cover 114 of module housing 102. Example elastic member 110 may be a spring (e.g., a compression spring). In some examples, elastic member 110 may have any other structure and configurations while ensuring the function of elastic member 110. Elastic member 110 may provide an upward thrust to rotary magnetizer 108 and protruding screw 106 to ensure that protruding screw 106 extends out of module housing 102.

Furthermore, magnet-driven connector 100 may include a low-friction film 112 disposed between core module 104 and module housing 102. Low-friction film 112 may include a low-friction material that may not impede the rotation of core module 104 and may ease relative movement between core module 104 and module housing 102. For example, low-friction film 112 may include a polytetrafluorethylene film or a similar polymeric material. In one example, low-friction film 112 may reduce friction between core module 104 and module housing 102 during rotation of core module 104 (i.e., rotation of rotary magnetizer 108 and protruding screw 106).

FIG. 1B is a cross sectional view of example magnet-driven connector 100 of FIG. 1A, depicting additional features. For example, similarly named elements of FIG. 1B may be similar in structure and/or function to elements described with respect to FIG. 1A. As shown in FIG. 1B, low-friction film 112 may be disposed between core module 104 and module housing 102 such that a first space 156 is formed between module housing 102 and low-friction film 112, and a second space 158 is formed between core module 104 and low-friction film 112.

Further, rotary magnetizer 108 may magnetically drive protruding screw 106 to engage or disengage with a threaded hole 154 of a nut portion 152. In one example, magnet-driven connector 100 and nut portion 152 can be installed into a first mating component and a second mating component, respectively, to connect the first mating component and the second mating component.

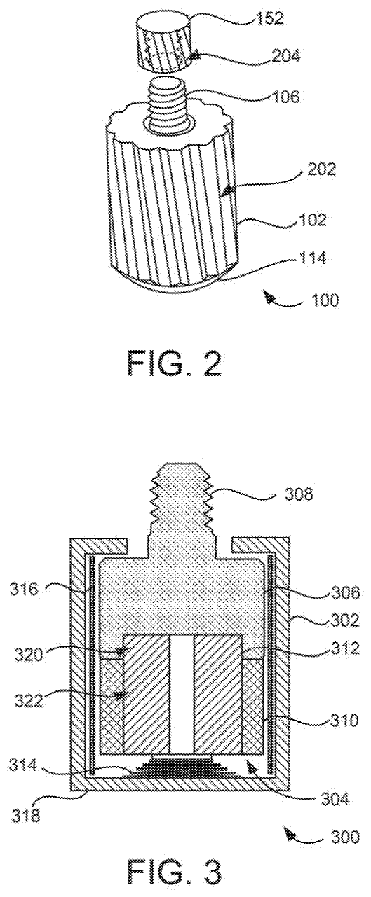

FIG. 2 is a schematic diagram of example magnet-driven connector 100 of FIG. 1A, depicting a non-smooth texture 202 on an outer surface. For example, similarly named elements of FIG. 2 may be similar in structure and/or function to elements described with respect to FIG. 1B. As shown in FIG. 2, module housing 102 may include non-smooth texture 202 on an outer surface to facilitate magnet-driven connector 100 to be installed into the first mating component. Similarly, nut portion 152 may include a non-smooth texture 204 on an outer surface to facilitate nut portion 152 to be installed into the second mating component.

In one example, the first mating component and the second mating component may include a plastic material. Example non-smooth texture may be a knurling structure. In this example, magnet-driven connector 100 and nut portion 152 can be installed into the first mating component and the second mating component, respectively, for instance via a heat staking insert process. In other examples, the non-smooth texture may be a threaded structure. In this example, magnet-driven connector 100 and nut portion 152 can be respectively screwed into a corresponding opening defined in the first mating component and the second mating component.

FIG. 3 is a cross-sectional view of an example magnet-driven connector 300, depicting a magnet 312 rotatably received in a screw portion 306 and non-rotatably received in a magnet holder 310. Magnet-driven connector 300 may include a module housing 302 and a core module 304 disposed in module housing 302. Core module 304 may include screw portion 306 having a protruding screw 308 and a first cavity 320. Further, core module 304 may include magnet holder 310 in contact with screw portion 306 and having a second cavity 322. Furthermore, core module 304 may include magnet 312 rotatably received in first cavity 320 and non-rotatably received in second cavity 322. In some examples, core module 304 may include four magnets disposed on four sides within first cavity 320 and second cavity 322.

Further, magnet-driven connector 300 may include an elastic member 314 disposed between core module 304 and a bottom cover 318 of module housing 302 to provide an upward thrust to core module 304. Furthermore, magnet-driven connector 300 may include a low-friction film 316 (e.g., a polytetrafluorethylene film) disposed between core module 304 and module housing 302. In one example, low-friction film 316 may be disposed between core module 304 and module housing 302 such that a first space (e.g., first space 156 as shown in FIG. 1B) is formed between module housing 302 and low-friction film 316 and a second space (e.g., second space 158 as shown in FIG. 18) is formed between core module 304 and low-friction film 316.

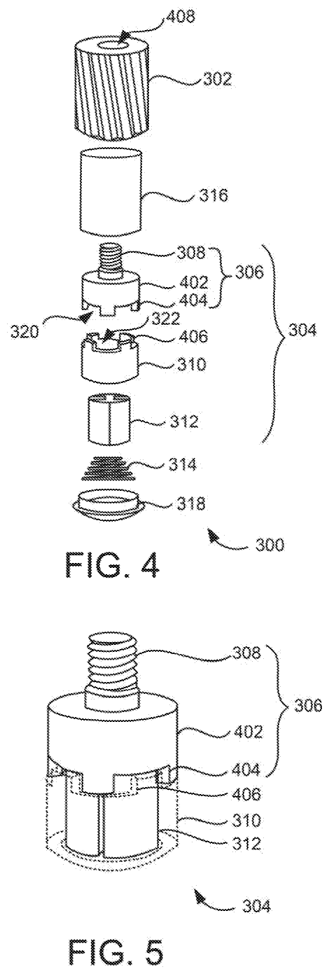

FIG. 4 is an exploded view of example magnet-driven connector 300 of FIG. 3, depicting additional features. For example, similarly named elements of FIG. 4 may be similar in structure and/or function to elements described with respect to FIG. 3. As shown in FIG. 4, magnet-driven connector 300 may be a cylindrical structure. For example, module housing 302, core module 304, and low-friction film 316 may be cylindrical in shape.

Further, screw portion 306 may include a limit base 402 defining first cavity 320. Further, limit base 402 may include a downwardly extending first jaw 404 at a first end. In this example, protruding screw 308 may be provided on limit base 402 at a second end that is opposite the first end. Furthermore, magnet holder 310 may include an upwardly extending second jaw 406 to engage with first jaw 404. Also, module housing 302 may include an opening 408 on a top side (i.e., opposite to bottom cover 318). Elastic member 314 may provide an upward thrust to core module 304 to ensure that protruding screw 308 extends out of module housing 302 through opening 408. An example assembly of core module is explained in FIG. 5.

FIG. 5 is a schematic diagram of example core module 304 of FIG. 4, depicting magnet holder 310 to fixedly hold magnet 312 and in contact with screw portion 306, for instance, via first jaw 404 and second jaw 406. For example, similarly named elements of FIG. 5 may be similar in structure and/or function to elements described with respect to FIG. 4. As shown in FIG. 5, second jaw 406 may be engaged with first jaw 404. In one example, magnet holder 310 may rotate with magnet 312 (e.g., when magnet 312 is driven by an external magnet device) such that second jaw 406 may contact first jaw 404 to drive rotation of screw portion 306. In this example, the rotation of screw portion 306 may cause protruding screw 308 to be tightened or loosened relative to a threaded hole of a nut portion.

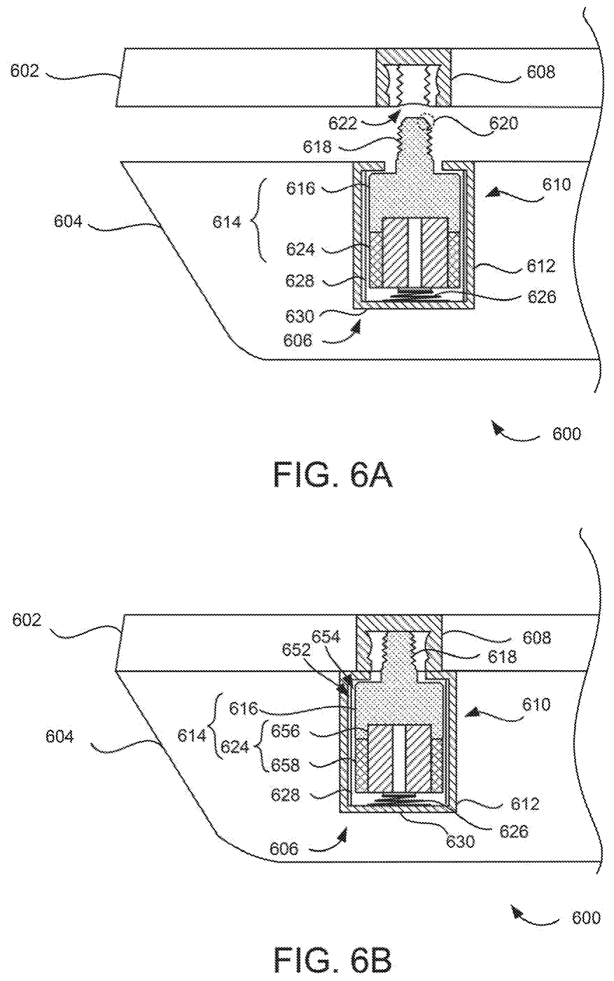

FIGS. 6A and 6B are cross-sectional views of a portion of an example device housing 600 including an example connector 606 to connect a first cover 602 and a second cover 604. For example, first cover 602 and second cover 604 may be connected to form device housing 600 (e.g., an enclosure) of an electronic device. Example electronic device may include, but not limited to, a laptop, a convertible device, a personal digital assistance (PDA), a notebook, a sub-notebook, a personal gaming device, a camera, a mobile phone, or any other device that may house electronic components. Example convertible device may refer to a device that can be “converted” from a laptop mode to a tablet mode.

Example device housing 600 may be a keyboard housing, a display housing, or the like. For example, the keyboard housing may house a keyboard, a battery, a touchpad, and so on. The display housing may house a display (e.g., a touchscreen display). Example display may include liquid crystal display (LCD), light emitting diode (LED), electro-luminescent (EL) display, or the like. In other examples, device housing 600 may house other components such as a camera, audio/video devices, and the like, depending on the functions of the electronic device.

For example, a notebook computer may include a keyboard housing and a display housing. The display housing may be formed by combining A-cover and B-cover and the keyboard housing may be formed by combining C-cover and D-cover. In this example, A-cover and B-cover or C-cover and D-cover may be combined using connector 606.

Device housing 600 may include first cover 602 and second cover 604. Particularly, FIG. 6A is a cross-sectional view of the portion of example device housing 600, depicting first cover 602 and second cover 604 in a detached position and FIG. 6B is a cross-sectional view of the portion of example device housing 600, depicting first cover 602 and second cover 604 in a combined position.

Device housing 600 may include connector 606 to connect first cover 602 and second cover 604. In one example, connector 606 may include a female connector 608 installed into first cover 602 and a male connector 610 installed into second cover 604. For example, female connector 608 and male connector 610 may be cylindrical structures. The center of female connector 608 may be provided with an open downwardly threaded hole 622. Female connector 608 and male connector 610 may include a non-smooth texture on an outer surface to facilitate female connector 608 and male connector 610 to be installed into first cover 602 and second cover 604, respectively.

For example, the non-smooth texture may be a knurling structure. In this example, female connector 608 and male connector 610 may be installed into first cover 602 and second cover 604, respectively, via a heat staking insert process. In example heat staking insert process, female connector 608 and male connector 610 may be preheated with induction and then pressed into an opening defined in a corresponding plastic part of first cover 602 and second cover 604, respectively.

Male connector 610 may include a module housing 612 and a core module 614 disposed in module housing 612. Core module 614 may include a screw portion 616. Screw portion 616 may include a protruding screw 618 and a chamfer 620 on protruding screw 618 to align threaded hole 622 of female connector 608 and protruding screw 618. Chamfer 620 may be provided on an end of protruding screw 618 to guide protruding screw 618 to align with threaded hole 622 when protruding screw 618 rotates.

Further, core module 614 may include a rotary magnetizer 624 in contact with screw portion 616 to magnetically drive protruding screw 618 to engage or disengage with female connector 608. Further, male connector 610 may include an elastic member 626 between core module 614 and a bottom cover 630 of module housing 612. Furthermore, male connector 610 may include a low-friction film 628 disposed between core module 614 and module housing 612 to prevent core module 614 being stuck during rotation of protruding screw 618.

As shown in FIG. 68, male connector 610 may include a first space 652 between module housing 612 and low-friction film 628 and a second space 654 between core module 614 and low-friction film 628 to provide tolerance. Further as shown in FIG. 68, rotary magnetizer 624 may include a magnet 656 and a magnet holder 658 to fixedly hold magnet 656 and in contact with screw portion 616. Magnet 656 may magnetically drive protruding screw 618, via magnet holder 658, to mate with female connector 608. In other examples, screw portion 616 and magnet holder 658 can be implemented as a single piece structure.

In one example, magnet 656 may be actuatable from outside device housing 600 by means of a magnetic drive field. For example, magnet 656 may be drivable by means of a time varying magnetic drive field that is effective on magnet 656 from outside device housing 600 into a rotary movement and/or a linear movement within device housing 600. In one example, magnet 656 may be drivable in a rotary manner by means of an external magnet device, for instance, an electric or pneumatic tool. Further, magnet holder 658 may rotate along with magnet 656 as magnet holder 658 may be fixedly holding magnet 656. The rotation of magnet holder 658 may drive protruding screw 618 to rotate in a clockwise or an anti-clockwise direction such that protruding screw 618 can be connected to or detached from threaded hole 622. In one example, protruding screw 618 may be rotated in the clockwise direction to combine first cover 602 and second cover 604. In another example, protruding screw 618 may be rotated in the anti-clockwise direction to detach/separate first cover 602 and second cover 604. Thus, examples described herein may improve the aesthetic appearance of device housing 600 and/or any other structures as no parts of connector 606 can be exposed after installation and also provide an enhanced connection strength between first cover 602 and second cover 604. Also, examples described herein may enhance the serviceability and/or service life of the electronic devices.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A magnet-driven connector comprising:
a module housing;
a core module disposed in the module housing, wherein the core module comprises:
a protruding screw; and
a rotary magnetizer in contact with the protruding screw to magnetically drive the protruding screw to engage or disengage with a threaded hole of a nut portion;
an elastic member between the core module and a bottom cover of the module housing; and
a low-friction film disposed between the core module and the module housing.

2. The magnet-driven connector of claim 1, wherein the low-friction film is a polytetrafluorethylene film.

3. The magnet-driven connector of claim 1, wherein the low-friction film is to reduce friction between the core module and the module housing during rotation of the core module.

4. The magnet-driven connector of claim 1, wherein the low-friction film is disposed between the core module and the module housing such that a first space is formed between the module housing and the low-friction film, and a second space is formed between the core module and the low-friction film.

5. The magnet-driven connector of claim 1, wherein the module housing comprises a non-smooth texture on an outer surface to facilitate the magnet-driven connector to be installed into a mating component.

6. A magnet-driven connector comprising:
a module housing;
a core module disposed in the module housing, wherein the core module comprises:
a screw portion comprising a protruding screw and a first cavity;
a magnet holder in contact with the screw portion and having a second cavity; and
a magnet rotatably received in the first cavity and non-rotatably received in the second cavity;
an elastic member disposed between the core module and a bottom cover of the module housing to provide an upward thrust to the core module; and
a low-friction film disposed between the core module and the module housing.

7. The magnet-driven connector of claim 6, wherein the screw portion comprises:
a limit base having the first cavity and a downwardly extending first jaw at a first end, wherein the protruding screw is provided on the limit base at a second end that is opposite the first end.

8. The magnet-driven connector of claim 7, wherein the magnet holder comprises an upwardly extending second jaw to engage with the first jaw, wherein the magnet holder is to rotate with the magnet such that the second jaw is to contact the first jaw to drive rotation of the screw portion, and wherein the rotation of the screw portion is to cause the protruding screw to be tightened or loosened relative to a threaded hole of a nut portion.

9. The magnet-driven connector of claim 6, wherein the low-friction film is disposed between the core module and the module housing such that a first space is formed between the module housing and the low-friction film and a second space is formed between the core module and the low-friction film, and wherein the low-friction film is a polytetrafluorethylene film.

10. A device housing comprising:
a first cover;
a second cover; and
a connector to connect the first cover and the second cover, wherein the connector comprises:
a female connector installed into the first cover; and
a male connector installed into the second cover, wherein the male connector comprises:
a module housing;
a core module disposed in the module housing, wherein the core module comprises:
a screw portion comprising:
a protruding screw; and
a chamfer on the protruding screw to align a threaded hole of the female connector and the protruding screw; and
a rotary magnetizer in contact with the screw portion to magnetically drive the protruding screw to engage or disengage with the female connector;
an elastic member between the core module and a bottom cover of the module housing; and
a low-friction film disposed between the core module and the module housing.

11. The device housing of claim 10, wherein the male connector and the female connector comprise a non-smooth texture on an outer surface to facilitate the female connector and the male connector to be installed into the first cover and the second cover, respectively, and wherein the non-smooth texture is a knurling structure.

12. The device housing of claim 10, wherein the female connector and the male connector are installed into the first cover and the second cover, respectively, via a heat staking insert process.

13. The device housing of claim 10, wherein the male connector comprises a first space between the module housing and the low-friction film and a second space between the core module and the low-friction film to provide tolerance, and wherein the low-friction film is a polytetrafluorethylene film.

14. The device housing of claim 10, wherein the rotary magnetizer comprises:
a magnet; and
a magnet holder to fixedly hold the magnet and in contact with the screw portion, wherein the magnet is to magnetically drive the protruding screw, via the magnet holder, to mate with the female connector.

15. The device housing of claim 10, wherein the female connector and the male connector are cylindrical structures.
